(19) United States
(12) Patent Application Publication
(10) Pub. No.: US 2008/0150676 A1
(43) Pub. Date: Jun. 26, 2008

(54) KEYLESS LOCKING SYSTEM FOR TOOL BOXES

(75) Inventors: Thomas Ennis, Long Beach, CA (US); Richard Ennis, Long Beach, CA (US)

Correspondence Address: Rutan & Tucker, LLP., 611 ANTON BLVD, SUITE 1400, COSTA MESA, CA, 92626, US

(73) Assignee: T & E Concrete, Inc., Long Beach, CA (US)

(21) Appl. No.: 11/924,339

(22) Filed: Oct. 25, 2007

Related U.S. Application Data
(60) Provisional application No. 60/863,032, filed on Oct. 26, 2006.

(51) Int. Cl. B65D 55/14; E05B 65/52

(52) U.S. Cl. 340/5.1; 70/159; 70/57.1

(57) ABSTRACT

A system and method for locking a tool box is provided. The system utilizes a remote device transmitter and receiver that may be used in conjunction with each other to facilitate locking of a tool box. The system and method also utilizes a hand held remote control unit which incorporates the transmitter whereby when a user desires to lock and/or unlock the tool box, the user simply depresses a button on the remote and the receiver within the tool box causes for locking of the box. Additionally, the system and method may be utilized for a plurality of differing tool boxes allowing for a number of boxes to be locked with a single signal being sent to each box.

### FIELD OF THE INVENTION

The invention relates generally to the field of tool boxes. More specifically, the present invention relates to a system and method for automatically, and remotely locking tool boxes and/or a plurality of tool boxes without the need for associated keys.

### BACKGROUND OF THE INVENTION

Tool boxes are used by just about everyone in today's society, from do it yourself home owners, tradesmen and construction workers.

Tools and tool boxes are of the utmost importance to individuals that make their living off the use of tools. Specifically, tradesmen, such as construction workers, plumbers, electricians and many others use very sophisticated and expensive tools. The use of a tool box to house, store and/or protect these tools is very important. Most tool boxes have storage units and compartments to house important, and even small parts, tools and accessories. Most of these tradesmen carry these tool boxes as either portable tool boxes or have them mounted inside their trucks/vehicles to allow them to carry more easily from one job location to the next job location. Many tradesmen rely on their trucks/vehicles to transport tools and materials to the job site. Because of the sizable investment in tools and the cost of lost time when a tool is missing or not functioning, it is essential that tools be protected from theft and from the weather. Therefore, many of the tool boxes are elaborate and expensive.

Typically the took boxes have locks on them to protect them from being stolen and/or misplaced. Because of the relative expense of the tools, they are valuable and if lost, stolen or misplaced, they are expensive and cumbersome to replace. Therefore, many tradesmen take great pains to protect and account for all their tools. Therefore, most tool boxes are locked by lock and key to allow only the owner to access the box.

However, one persistent problem is that many of these tradesmen forget to lock their tool boxes, thereby leaving them susceptible to theft by others. Additionally, many tradesmen have multiple tool boxes containing different tools of different sizes, and therefore because there are multiple tool boxes, there are also multiple locks to these tool boxes.

Therefore, a need exists for an improved tool box locking mechanism and system for locking a tool box and/or a plurality of tool boxes when not in use.

Additionally, there is a need exists for a tool box locking mechanism and system that may lock a tool box and/or a plurality of tool boxes from a position remote from the box and whereby the remote locking of a tool box may reduce the risk of forgetting to lock all the tool boxes. Moreover, a need exists for remote locking from a greater distance from the tool box whereby a user may lock the box without the need to be in close proximity to the box.

### SUMMARY OF THE INVENTION

The present invention relates to a system and method for locking a tool box. The system includes a remote device transmitter and receiver that may be used in conjunction with each other to facilitate locking of a tool box. The system and method utilizes a hand held remote control unit which incorporates the transmitter, whereby when a user desires to lock and/or unlock the tool box, the user simply depresses a button on the remote and the receiver within the tool box causes for locking of the box. Additionally, the system and method may be utilized for a plurality of differing tool boxes allowing for a number of boxes to be locked with a single signal being sent to each box.

To this end, in an exemplary embodiment of the present invention, a system for remotely locking/unlocking a tool box is provided. The system has a box having a container portion and a lid component. Additionally, the system has a locking mechanism that attaches the container portion to the lid component and an actuator arm wherein the actuator arm allows for the lid component to be detached and opened relative the container portion. Moreover, the system has a receiver unit attached to the locking mechanism and actuator arm.

In an exemplary embodiment, the system has a remote transmitter that sends a wireless signal to the receiver unit.

In an exemplary embodiment, the system has an actuator unit having a shaft attached to the actuator arm to prevent movement of the actuator arm.

In an exemplary embodiment, the system has a solenoid and a shaft attached to the solenoid whereby when activated, the shaft interferes with the actuator arm thereby causing the arm to be disabled.

In an exemplary embodiment, the system has an alarm system attached to the locking mechanism whereby when the box is tampered with, the alarm system is activated to notify the remote transmitter of such interruption.

In an exemplary embodiment, the system has the ability to program a plurality of different boxes with receiver units whereby a single remote transmitter may activate and/or deactivate a plurality of different receiver units thereby causing for the locking and/or unlocking of a plurality of boxes.

In an exemplary embodiment, the system has an actuator unit having a shaft attached to the actuator arm to prevent movement of the actuator arm whereby the actuator unit may be programmed to open at a pre-determined angle for entry into the box.

In an exemplary embodiment, the system has a transmitter and receiver unit which communicate with one another with the use of Radio Frequency.

In an exemplary embodiment, the system has a transmitter and receiver unit which communicate with one another with the use of infrared signals.

To this end, in an exemplary embodiment of the present invention, an apparatus is provided that may be utilized for remote communication with a container. The apparatus has a container box having an interior container portion and a top cover portion and a locking mechanism attached to both the interior container portion and the top cover portion wherein the locking mechanism has a receiver unit container thereon. Additionally, the apparatus has an actuator arm wherein the actuator arm allows for the lid component to be detached and opened relative the container portion and a locking mechanism attached to the actuator arm.

In an exemplary embodiment, the apparatus has a hand held remote unit which activates the locking mechanism.

In an exemplary embodiment, the apparatus has a hand held remote unit having a transmitter which sends a signal to the receiver unit contained within the locking mechanism.

In an exemplary embodiment, the apparatus has a microprocessor in the locking mechanism whereby the microprocessor receives information from the receiver unit and instructs the locking mechanism and actuator arm to take the appropriate action.

In an exemplary embodiment, the apparatus has a hand held remote unit having a transmitter having a button connected to the transmitter to instruct a signal to be sent to the container and a dial whereby the remote unit dictates the opening and degree of angle of actuator angle.

In an exemplary embodiment, the apparatus has an actuator unit having a shaft attached to the actuator arm to prevent movement of the actuator arm whereby the actuator unit may be programmed to open at a pre-determined angle for entry into the box.

In an exemplary embodiment, the apparatus has an alarm system attached to the locking mechanism whereby when the container box is tampered with, the alarm system is activated to notify the remote unit of such interruption.

In an exemplary embodiment, the apparatus has a plurality of container boxes with receiver units whereby a single remote unit may activate and/or deactivate a plurality of different receiver units thereby causing for the locking and/or unlocking of a plurality of container boxes.

In an exemplary embodiment, the apparatus has a solenoid and a shaft attached to the solenoid whereby when activated, the shaft interferes with the actuator arm thereby causing the arm to be disabled.

In an exemplary embodiment, the apparatus has an actuator unit having a shaft attached to the actuator arm to prevent movement of the actuator arm.

In an exemplary embodiment, the apparatus has an indicator on the remote unit to indicate when the container box has been tampered with whereby the indicator may be visual and auditory.

In an exemplary embodiment the present invention is directed toward a system for remotely locking/unlocking a tool box. The system has a box having a container portion and a lid component. Additionally, the system has a locking mechanism that attaches the container portion to the lid component and an actuator arm wherein the actuator arm allows for the lid component to be detached and opened relative the container portion. Moreover, the system has a receiver unit attached to the locking mechanism and actuator arm.

In an exemplary embodiment, the system has a remote transmitter that sends a wireless signal to the receiver unit.

In an exemplary embodiment, the system has an actuator unit having a shaft attached to the actuator arm to prevent movement of the actuator arm.

In an exemplary embodiment, the system has a solenoid and a shaft attached to the solenoid whereby when activated, the shaft interferes with the actuator arm thereby causing the arm to be disabled.

In an exemplary embodiment, the system has an alarm system attached to the locking mechanism whereby when the box is tampered with, the alarm system is activated to notify the remote transmitter of such interruption.

In an exemplary embodiment, the system has the ability to have programming for a plurality of different boxes with receiver units. Whereby, a single remote transmitter may activate and/or deactivate a plurality of different receiver units thereby causing for the locking and/or unlocking of a plurality of boxes.

To this end, in an exemplary embodiment of the present invention, a system and method for remote locking of a tool box, is provided.

In another exemplary embodiment, a system and method is provided for remote locking of a tool box, wherein the system may allow for a plurality of tool boxes to be locked and/or unlocked simultaneously.

Yet another exemplary embodiment of the present invention is to provide a system and method for remote locking of a tool box wherein the system employs a transmitter and a receiver.

Still another exemplary embodiment of the present invention is to provide a system and a method for remote locking of a tool box. Wherein the system utilizes a remote transmitter that may be used from a significant distance from the box.

An exemplary embodiment of the present invention is to provide a system and method for remote locking of a tool box, wherein the system is completely keyless in nature, but may provide an emergency key entry if the electrical system fails.

Another exemplary embodiment of the present invention is to provide a system and method for remote locking of a tool box wherein the system may discourage theft of tools and/or objects that are stored within the locked tool box.

Still another exemplary embodiment of the present invention is to provide a system and method for remote locking of a tool box wherein the system may lock/unlock a plurality of tool boxes.

An exemplary embodiment of the present invention is to provide a system and a method for remote locking of a tool box wherein the system may be programmed and re-programmed to lock a plurality of tool boxes.

Yet another exemplary embodiment of the present invention is to provide a system and a method for remotely locking/unlocking a tool box, wherein the system utilizes an actuator that may effect locking of the box and may be linked to an alarm system.

Still another exemplary embodiment of the present invention is to provide a system and a method for remotely locking/unlocking a tool box, wherein the system utilizes a solenoid and a shaft that is attached to the locking arms of the handle of a box thereby causing the box to be locked.

Another exemplary embodiment of the present invention is to provide a system and a method for remote locking/unlocking of a tool box wherein the system utilizes an arm command on a remote transmitter to activate a actuator or solenoid to extend the shaft and block the locking arms from being able to turn and open the tool box.

An exemplary embodiment of the present invention is provide a system and a method for remotely locking/unlocking a tool box wherein the system utilizes an alarm system to notify an owner if the box has been tampered with or if someone is attempting to forcibly open the tool box.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWING

FIG. 1 is a front perspective view of the system for remote locking of a tool box in an exemplary embodiment of the present invention;

FIG. 2 is a side view of the system in an exemplary embodiment of the present invention; and

FIG. 3A is another side view of the system in an exemplary embodiment of the present invention.

FIG. 3B is close up view of the locking mechanism in an exemplary embodiment of the present invention

FIG. 4 is a view of the hand held remote system in an exemplary embodiment of the present invention.

FIG. 5 is a perspective view of the system in an exemplary embodiment of the present invention.

### DETAILED DESCRIPTION OF THE PREFERRED EMBODIMENT

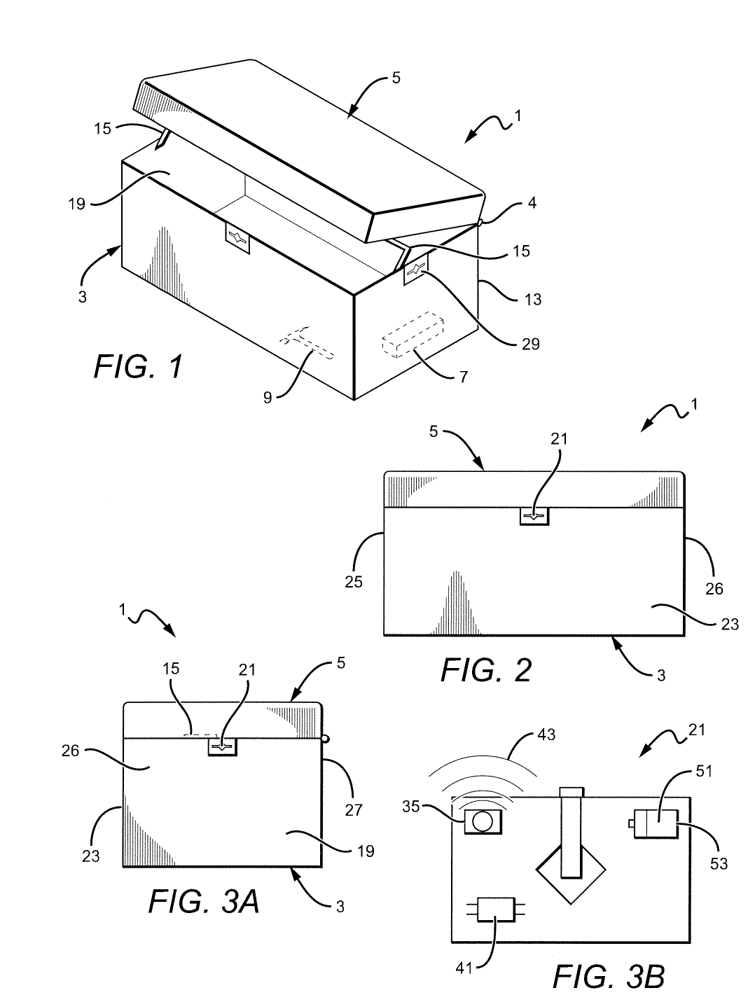

Turning now to the drawings wherein elements are identified by numbers and like elements are identified by like numbers throughout the 5 figures. The invention is depicted in FIG. 1 and illustrates a system and a method for rewarding participation in an online activity.

Referring to FIG. 1 illustrates a typical prior art tool box 1 in one exemplary embodiment. The typical prior art box 1 may be constructed of a plurality of different materials including metal, allows, plastics, wood and the like. Most tool box units 1 have at least a bottom container portion 3 and a top cover portion 5 whereby the top cover portion 5 is significantly smaller in size than the bottom container portion 3. The bottom container portion 3 is sufficiently sized to accommodate a plurality of articles 7 contained therein including tools 9 and the like. The bottom container portion 3 may also be shaped to fit into the conventional bed of a truck (not shown) such that the container 1 may be transported from one location to another. The top cover portion 5 is adapted to fit over the bottom container portion 3 and to provide a seal between the top cover portion 5 and the bottom container portion 3. A hinge 4 may also be provided to allow for the top cover portion 5 to pivot about the bottom container portion 3 and close same. The hinge 11 may be located at the back 13 of the bottom container portion 3 and the top cover portion 5 and may be removably attached to both portions.

Additionally, a hydraulic actuator 15 may be provided whereby the actuator 15 may allow for tilting of the top cover portion 5 about the bottom container portion 3. The actuator 15 may also allow for the user to open the top cover portion 5 and hold the top cover portion 5 open while the user looks for a specific article 7 contained within the bottom container portion 3. The actuator 15 may also allow hinging and locking of the top cover portion 5 at a plurality of angles relative to the bottom container portion 2 such that the user may open the top cover portion 5 in any angle they desire and lock the cover portion 5 into that angle until they desire to close the container 1 apparatus. The bottom container apparatus 3 has a interior portion 19 that may be adapted to hold a plurality of different articles 7 including tools 9. Additionally, the bottom container 3 portion may have an interior portion 19 that may be configured to hold specific hardware, and/or small articles, such as nuts, bolts, nails and the like.

Referring to FIG. 2, the present invention further includes a locking mechanism 21 contained on the front portion 23 of the container apparatus 1. The locking mechanism 21 may be attached to both the top cover portion 5 and the bottom container portion 3 whereby when engaged, the locking mechanism 21 does not allow for manipulation and hinging of the top cover portion 5 relative to the bottom container portion 3. The locking mechanism 21 in one embodiment is located at the front panel 23 of both the top cover portion 5 and the bottom container portion 3. However, it should be understood that the locking mechanism 21 may be located on a first side panel 25, a second side panel 26 and/or on the back panel 27 of both the top cover portion 5 and the bottom container portion 3. In an exemplary embodiment, a plurality of locking mechanisms 21 are provided whereby a first locking mechanism 21 may be located at the first side panel 25 and the second locking mechanism 29 may be located on the second side panel 26 as illustrated in FIG. 3A. Additionally, the locking mechanism 21 may be utilized using a plurality of different opening procedures. In an exemplary embodiment, the locking mechanism 21 may be opened manually with the use of a key (not shown). In another exemplary embodiment, the locking mechanism 21 may be manually opened with the use of a code (not shown) whereby the user enters a code into the locking mechanism 21 and the locking mechanism 21 is caused to be opened and/or closed with the entry of the code. By this means, the user may manually engage and/or disengage the locking mechanism 21 when desired.

However, in an exemplary embodiment of the present invention, the locking mechanism 21 may be remotely operated with a hand held unit 31 operated by a user. The hand held unit 31 may allow the operator and/or user to remotely lock the locking mechanism 21 of the container apparatus from a remote location. The hand held unit 31 may utilize an Radio Frequency (RF) signal that may be received by a receiver 35 located within the locking mechanism 21 housing. When the RF signal is received by the receiver 35 in the locking mechanism 21, the receiver 35 sends the signal to a microprocessor 41 which instructs the locking mechanism 21 to lock. The locking mechanism 21 may then send a signal 43 to the user that informs the user that the locking mechanism 21 is indeed locked. Such as signal may be in the form of a light 45 contained on the remote operated hand held unit 31 and/or an auditory signal 47 sent by the locking mechanism 21 and/or the hand held unit 31 to signal that the unit has been locked.

Additionally, the remote hand held unit 31 may be utilized on a plurality of different container apparatus 1, when a single user may have a plurality of different container boxes 1. Where the user wishes to authenticate that the plurality of boxes 1 are locked and/or unlocked when in use. The single RF signal 47 may be sent to a plurality of container boxes 1 whereby each container box has its own receiver 35 and microprocessor 41. When the signal 47 is received by the container box 1 and sent to the microprocessor 41, the microprocessor 41 for each respective container apparatus 1 may instruct each container box 1 to lock and/or unlock depending on the signal 47 received from the hand held unit 31.

As illustrated in FIG. 3B, the locking mechanism 21 may have a power source 51 contained therein. The power source 51 may be a battery 53 whereby the battery powers 53 the micro processor 41 and the receiver unit 35. However, because many of these containers are housed outdoors, it is contemplated that the power source 51 may be solar whereby solar panels (not shown) are provided and whereby the solar panels collect the necessary power to power the micro processor 41, the receiver unit 35 and the actuator 15. Additionally, the power source 51 may be utilized to power the actuator 15. In an exemplary embodiment of the present invention, the locking mechanism 21 may be removably attached to the actuator 15 whereby when the locking mechanism 21 is triggered to open, the actuator 15 is instructed by the micro processor 41 within the locking mechanism 21 to activate the actuator 15 which causes the top cover portion 5 of the container apparatus 1 to open. The actuator 15 is connect to both the top cover portion 5 and the bottom container portion 3 of the container apparatus 1. When the actuator 15 is instructed by the microprocessor 41, the actuator 15 will cause the top cover portion 5 to open vis-à-vis the bottom container portion 3. Additionally, the micro-processor 41 may cause the actuator 15 to become locked into a specific desired angle which is pre-set by the individual user having the hand held remote unit 31.

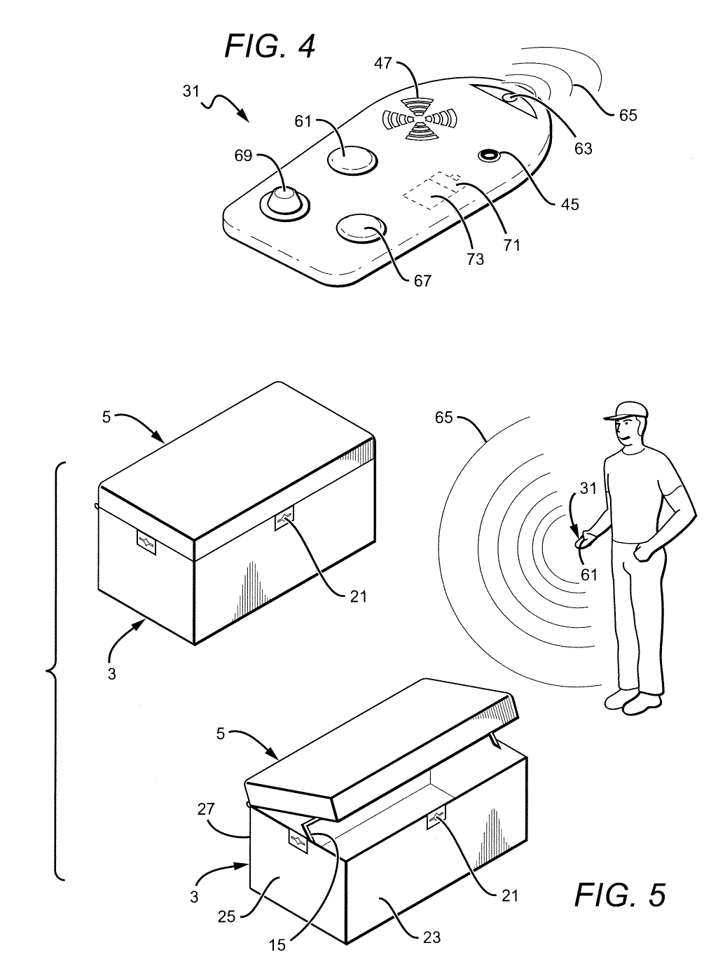

FIG. 4 illustrates the hand held remote unit 31. As can be seen in the FIG. 4, the hand held remote unit 31 may have a first button 61 located thereon. The first button 61 may be depressed by an individual user to lock the locking mechanism 21 located on the container apparatus 1. Upon depressing the first button 61, the hand held remote unit 31 has a transmitter 63 that transmits an RF and/or Infrared (IR) signal 65 to a corresponding receiver 35 located within the container apparatus 1. The transmitter 63 may also send a broad signal to be received by a plurality of different receivers 35 located in a plurality of different container apparatus 1 such that when received, the receivers 35 within the plurality of locking mechanisms 21 will cause all affected locking mechanisms to become locked.

Additionally, as illustrated in FIG. 4, the hand held remote unit 31 may have a second button 67 located thereon. The second button 67 may be utilized by the individual to unlock and set the angle of the top cover portion 5 opening if desired by the user. When depressed, the remote unit will send via the transmitter 63 a signal 65 to the receiver 35 located within the locking mechanism 21 whereby the locking mechanism 21 will be unlocked when the proper authorization from the microprocessor 41 instructs the locking mechanism 21 to disengage and/or open. Additionally, the hand held unit 31 may have a dial thereon whereby the dial 69 may allow the user to specify the angle in which they wish the top cover portion 5 to open when actuated by the individual. FIG. 4 further illustrates that the hand held remote unit 31 may have a power source 41 contained therein. In an exemplary embodiment, the power source 71 may be a battery 73.

FIG. 5 illustrates the system in use. As illustrated, a individual may have a hand held unit 31 in their hand whereby upon depressing the first button 61 on the remote, a signal 65 is sent to the receiver 35 located within the locking mechanism 21. Upon receipt of the signal 65 from the transmitter 63, the receiver 35 in the locking mechanism 21 sends the information to the micro-processor 41 which in turn allows for locking of the mechanism 21 by the individual from a remote location. Moreover, an individual may have the hand held unit 31 whereby upon depressing the second button 67 on the remote, the signal 65 is sent from the internal transmitter 63 to the receiver 35 in the locking mechanisms 21 whereby the receiver 35 receives the signal 65, sends the signal 65 to the microprocessor 41 which in turn activates the locking mechanism 21 to unlock. Further, if required by the user, the locking mechanism 21 may activate the actuator 15 which may cause the actuator to open the top cover portion 5 of the container 1.

Thus, specific embodiments and applications of a safety device system have been disclosed. It should be apparent however, to those skilled in the art, that many more modifications besides those already described are possible without departing from the inventive concepts herein. The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A system for remotely locking/unlocking a tool box, the system comprising:
a box having a container portion and a lid component;
a locking mechanism that attaches the container portion to the lid component;
an actuator arm wherein the actuator arm allows for the lid component to be detached and opened relative to the container portion; and
a receiver unit attached to the locking mechanism and actuator arm.

2. The system of claim 1 further comprising:
a remote transmitter that sends a wireless signal to the receiver unit.

3. The system of claim 1 further comprising:
an actuator unit having a shaft attached to the actuator arm to prevent movement of the actuator arm.

4. The system of claim 1 further comprising:
a solenoid and a shaft attached to the solenoid whereby when activated, the shaft interferes with the actuator arm thereby causing the arm to be disabled.

5. The system of claim 1, further comprising:
an alarm system attached to the locking mechanism whereby when the box is tampered with, the alarm system is activated to notify the remote transmitter of such interruption.

6. The system of claim 1 further comprising:
programming a plurality of different boxes with receiver units whereby a single remote transmitter may activate and/or deactivate a plurality of different receiver units thereby causing for the locking and/or unlocking of a plurality of boxes.

7. The system of claim 1 further comprising:
an actuator unit having a shaft attached to the actuator arm to prevent movement of the actuator arm whereby the actuator unit may be programmed to open at a pre-determined angle for entry into the box.

8. The system of claim 1 further comprising:
a transmitter and receiver unit which communicate with one another with the use of Radio Frequency.

9. The system of claim 1 further comprising:
a transmitter and receiver unit which communicate with one another with the use of infrared signals.

10. An apparatus utilized for remote communication with a container, the apparatus comprising:
a container box having an interior container portion and a top cover portion;
a locking mechanism attached to both the interior container portion and the top cover portion wherein the locking mechanism has a receiver unit container thereon;
an actuator arm wherein the actuator arm allows for the lid component to be detached and opened relative the container portion; and
said locking mechanism attached to the actuator arm.

11. The apparatus of claim 10, further comprising:
a hand held remote unit which activates the locking mechanism.

12. The apparatus of claim 10, further comprising:
a hand held remote unit having a transmitter which sends a signal to the receiver unit contained within the locking mechanism.

13. The apparatus of claim 10, further comprising:
a microprocessor in the locking mechanism whereby the microprocessor receives information from the receiver unit and instructs the locking mechanism and actuator arm to take the appropriate action.

14. The apparatus of claim 10, further comprising:
a hand held remote unit having a transmitter having a button connected to the transmitter to instruct a signal to be sent to the container and a dial whereby the remote unit dictates the opening and degree of angle of actuator angle.

15. The apparatus of claim 10 further comprising:
said actuator unit having a shaft attached to the actuator arm to prevent movement of the actuator arm whereby the actuator unit may be programmed to open at a pre-determined angle for entry into the box

16. The apparatus of claim 10, further comprising:
an alarm system attached to the locking mechanism whereby when the container box is tampered with, the alarm system is activated to notify the remote unit of such interruption.

17. The apparatus of claim 10, further comprising:
a plurality of container boxes with receiver units whereby a single remote unit may activate and/or deactivate a plurality of different receiver units thereby causing for the locking and/or unlocking of a plurality of container boxes.

18. The apparatus of claim 10, further comprising:
a solenoid and a shaft attached to the solenoid whereby when activated, the shaft interferes with the actuator arm thereby causing the arm to be disabled.

19. The apparatus of claim 10, further comprising:
an actuator unit having a shaft attached to the actuator arm to prevent movement of the actuator arm.

20. The apparatus of claim 10, further comprising:
an indicator on the remote unit to indicate when the container box has been tampered with whereby the indicator may be visual and auditory.
